(19) United States
(12) Patent Application Publication
(10) Pub. No.: US 2019/0108528 A1
(43) Pub. Date: Apr. 11, 2019

(54) METHODS AND APPARATUS FOR CARD FRAUD PROTECTION

(71) Applicant: Giesecke+Devrient Mobile Security America, Inc., Dulles, VA (US)

(72) Inventor: Sridhar RAMACHANDRAN, Rockville, MD (US)

(73) Assignee: Giesecke+Devrient Mobile Security America, Inc., Dulles, VA (US)

(21) Appl. No.: 16/156,428

(22) Filed: Oct. 10, 2018

Related U.S. Application Data
(60) Provisional application No. 62/570,460, filed on Oct. 10, 2017.

(51) Int. Cl. G06Q 20/40; G06F 17/30

(52) U.S. Cl. CPC G06Q 20/4093; G06F 17/30283

(57) ABSTRACT

A credit card provider server device collects data indicative of at least one of i) environment of a user, ii) activities of the user, and iii) other characteristics of the user. When the credit card provider server device receives, from a payment issuer server device, a context request requesting a user context at a time a payment request is made, the credit card provider server device generates a user context for the user. The user context includes one or more indications related to the one or both of the environment of the user and the activities of the user at the time of the payment request. The credit card provider server device transmits the user context to the payment issuer server device for use in authenticating the payment request.

### CROSS-REFERENCE TO RELATED APPLICATIONS

The present application claims the benefit of priority to U.S. Provisional Application No. 62/570,460, entitled “Methods and Apparatus for Card Fraud Protection,” which was filed on Oct. 10, 2017, and is incorporated herein by reference in its entirety.

### FIELD OF THE DISCLOSURE

The present disclosure relates generally to credit card processing and, more particularly, to credit card fraud protection.

### BACKGROUND

Credit cards are widely-used as a convenient and efficient method for providing payments for products and services. To provide a credit card payment, a card present (CP) transaction may be initiated. In a CP transaction, a user (e.g., a customer) may present the physical card to a merchant or service provider. Alternatively, a card not present (CNP) transaction may be initiated in which case the user may provide a credit card number to the merchant without physically providing the card to the merchant (e.g., over the phone or other communication, or over the internet, e.g., card on file (COF)). Unfortunately, fraudulent credit card transactions that are initiated without the knowledge of the actual cardholder are common and increasing. Various methods for authenticating payment requests have been employed in an effort to reduce occurrence of fraudulent transactions. For example, Europlay, MasterCard, and Visa (EMV) standard utilizes computer chips embedded in credit cards to authenticate payment transactions. The EMV standard has been shown to cause a reduction in CP fraudulent transactions, but such fraudulent transactions nonetheless remain relatively common. Moreover, the EMV standard is not useful in preventing CNP fraud. On the contrary, an increase of CNP fraudulent transactions has occurred in many developed countries upon introduction of the EMV standard. Accordingly, better authentication systems are needed to reduce fraudulent transactions, such as both CP and CNP fraudulent transactions.

### SUMMARY

In an embodiment, a method for generating user context for use in credit card transaction authentication includes collecting, using a processor of a credit card provider server device, context data indicative of at least one of i) environment of a user, ii) activities of the user and iii) other characteristics of the user. The method also includes receiving, at the processor of the credit card provider server device from a payment issuer server device, a context request, the context request requesting a user context at a time a payment request is made. The method additionally includes in response to receiving the request, generating, with the processor of the credit card provider server device based on the context data, the user context, wherein the user context includes one or more indications related to the one or more of the environment of the user, the activities of the user and the other characteristics of the user at the time of the payment request. The method further includes transmitting the user context from the credit card provider server device to the payment issuer server device, wherein the user context is for use in authenticating the payment request.

In another embodiment, a tangible, non-transitory computer readable medium, or media, storing machine-readable instructions that, when executed by one or more processors, cause the one or more processors to: collect context data indicative of one or both i) environment of a user and ii) activities of the user; receive, from a payment issuer server device, a context request requesting a user context at a time a payment request is made; in response to receiving the context request, generate, based on the context data, the user context, wherein the user context includes one or more indications related to the one or both of the environment of the user and the activities of the user at the time of the payment request; and cause the user context to be transmitted to the payment issuer server device, wherein the user context is for use in authenticating the payment request.

In yet another embodiment, a system comprises a user context database configured to store context data. The system also comprises a user context collection engine coupled to the database, the user context collection engine configured to receive context data indicative of one or both i) environment of a user and ii) activities of the user, and store the context data in the user context database. The system additionally includes a user context generator engine coupled to the database, the user context generator engine configured to: receive, from a payment issuer server device, a context request requesting a user context at a time a payment request is made; in response to receiving the context request, generate the user context based on the context data in the user context database, wherein the user context includes one or more indications related to the one or both of the environment of the user and the activities of the user at the time of the payment request; and cause the user context to be transmitted the payment issuer server device, wherein the user context is for use in authenticating the payment request.

### BRIEF DESCRIPTION OF THE DRAWINGS

For a more complete understanding of the present invention, needs satisfied thereby, and the objects, features, and advantages thereof, reference now is made to the following description taken in connection with the accompanying drawings.

FIG. 1 is a block diagram of a computing system in which techniques for payment request authentication using context data may be implemented, according to an embodiment;

FIG. 2 is a timing diagram illustrating an example method, that may be implemented in the computing system of FIG. 1, for authenticating a payment request using user context, according to an embodiment;

FIG. 3 is a flow diagram illustrating an example method, that may be implemented in the computing system of FIG. 1, for generating user context for use in credit card transaction authentication, according to an embodiment; and

FIG. 4 is a block diagram of a computer system suitable for implementing one or more components of the computing system of FIG. 1, according to an embodiment.

Embodiments of the present disclosure and their advantages are best understood by referring to the detailed description that follows. It should be appreciated that like reference numbers are used to identify like elements illustrated in one or more of the figures, wherein showings therein are for purposes of illustrating embodiments of the present disclosure and not for purposes of limiting the same.

### DETAILED DESCRIPTION

Various examples and embodiments of the present disclosure will now be described. The following description provides specific details for a thorough understanding and enabling description of these examples. One of ordinary skill in the relevant art will understand, however, that one or more embodiments described herein may be practiced without many of these details. Likewise, one skilled in the relevant art will also understand that one or more embodiments of the present disclosure can include other features and/or functions not described in detail herein. Additionally, some well-known structures or functions may not be shown or described in detail below, so as to avoid unnecessarily obscuring the relevant description.

Embodiments described herein generally relate to methods and apparatus for using a user context as a factor in authorizing a payment issue request for issuing a payment for a payment transaction, such as a credit card payment transaction. In various embodiments described herein, a credit card provider collects and aggregates various user context data indicative of activities of a user, environment of the user, and other characteristics, interactions and/or behavioral aspects of the user. User context data may be collected from various connected devices, such as mobile devices, wearable devices, smart devices such as smart thermostats, smart light switches, smart keychains, and the like, and/or from service provider devices, such as internet service provider servers, wireless service provider servers, utility provider company servers, etc., for example. Such context data may provide a signature, or a baseline, of daily environment (e.g., home environment) and activities (e.g., internet use, geographical location, etc.), as well as other interactions and characteristics, for the user. At a time a payment request for a credit card transaction is made, user context may be generated based on the user context data collected for the user, and the user context may be provided to a payment issuer (e.g., bank) for use in authenticating the payment request. User context data may indicate typical user environment, activities, location, etc. corresponding to the time of the payment request and/or may indicate current environment, activity, location, etc. of the user at the time of the payment request.

The payment issuer may utilize context generated for the user as a factor in generating a decision of whether to authorize or decline the requested payment. For example, the payment issuer may compare information about the requested transaction (e.g., the geographical location at which the requested transaction was initiated) to the user signature or baseline indicated by the user context generated for the user. Based on the comparison, the payment issuer may the determine a likelihood that the payment transaction is authentic and is actually made by the user and/or with knowledge of the user. If the determined likelihood that the transaction is authentic is relatively high, then the payment issuer may approve the payment. On the other hand, if the determined likelihood that the transaction is authentic is relatively low, then the payment issuer may decline the payment. As a more specific example of a potentially fraudulent transaction, if the context for the user indicates that the user is at home, or is likely to be at home, and the payment transaction is initiated at a place outside of the home (e.g., at a physical merchant location such as a store), then the payment issuer may determine that the transaction is not likely to be authentic, and may decline the payment. As another example of a potentially fraudulent transaction, if the context for the user indicates that the user is currently at a particular geographical location (e.g., the US), and the transaction is attempted in another geographical location (e.g., Japan), then the payment issuer may determine that the transaction is not likely to be authentic, and may decline the payment. On the other hand, if the geographical location indicated by the context of the user corresponds to the geographical location in which the transaction is initiated, this may indicate that the transaction is more likely to be authentic, and the payment issuer may approve the payment. In some embodiments, such user context may provide an additional authentication factor that may be used in addition to one or more other factors such as knowledge factors (e.g., passwords or other information known to the user), possession factors (e.g., a secure identification number (ID) issued to a user, a token embedded in the card, authentication message/number provided via email or text message, etc.), biometric factors (e.g., user fingerprints, user retina detection, user voice pattern detection, etc.), etc., or may be used individually, to provide a level of assurance (e.g., a low level of assurance) in credit card payment transaction authentication.

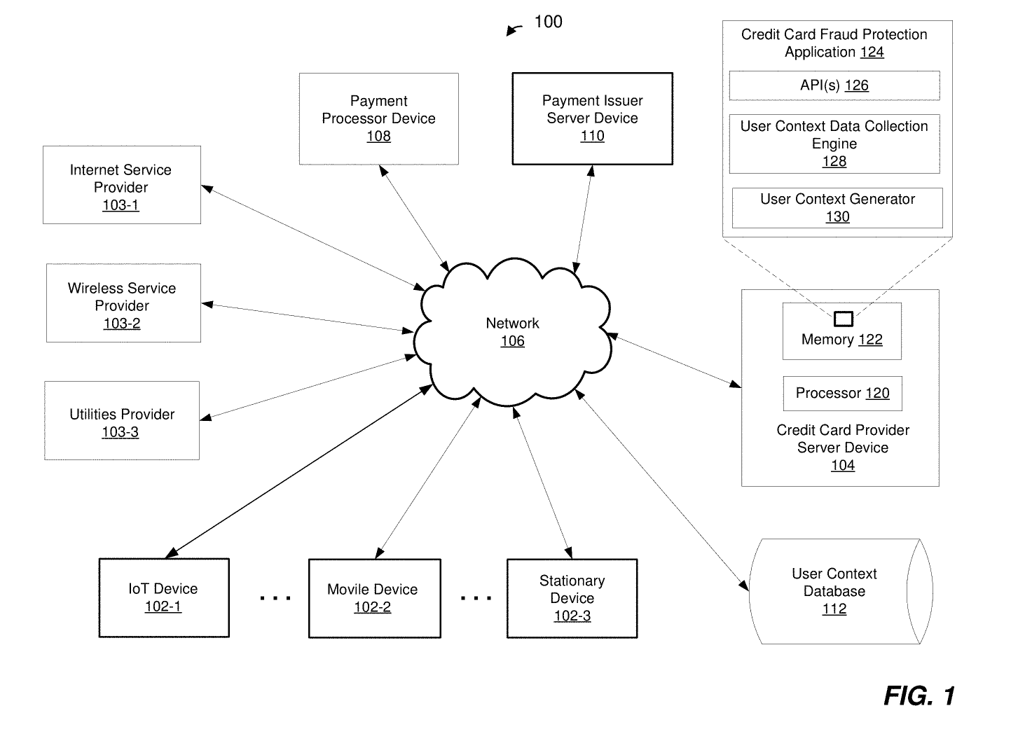

FIG. 1 is a block diagram of a computing system 100 in which techniques for payment request authentication user context data may be implemented, according to an embodiment. In such an embodiment, computing system 100 includes one or more user devices 102 and/or one or more service provider devices 103 communicatively coupled to a credit card service provider server device 104 via a network 106. Computing system 100 also includes a payment processor device 108, a payment issuer server device 110, and a user context database 112.

User devices 102 may include, for example, internet of things (IoT) devices 102-1, mobile devices 102-2, stationary computing devices 102-3, and other suitable web-enabled devices etc. that may provide context data for users. IoT devices 102-1 may include, for example, sensors that measure consumption of electricity in homes of users, sensors that measure consumption of water in homes of users, sensors that measure status of light sources (e.g., presence and/or absence of lights) in homes of users, actuators that control environment (e.g., temperature settings, light settings, etc.) in homes of users, actuators that open and/or close doors (e.g., garage doors, home entrance doors) in homes of users, etc. that may provide information about environment, daily activities, daily schedules, etc. of users. Mobile devices 102-2 may include cellular phones, tablets, wearables, etc. that may provide locations of users, physical activity of users, internet activities of users, etc. Stationary computing devices 102-3 may include personal computers, web-enabled televisions, etc. that may provide information about current or daily activities of users. Service provider devices 103 may include, for example, an internet service provider server device 103-1, a wireless service provider sever device 103-2 and one or more utilities provider server devices 103-3, such as a gas utilities provider server device, a water provider sever device, electricity provider server device, etc. Such service provider devices may collect and/or have access to, data regarding consumption patterns, usage, etc., of the corresponding servers by users.

Network 106 may be a wide area network (WAN) such as the Internet, a local area network (LAN), or any other suitable type of network or mode of communication. Network 106 may be single network or may be made up of multiple different networks, in some embodiments. As illustrated in FIG. 1, user context database 112 may be communicatively coupled to credit card service provider server device 104, payment issuer server device 108, one or more user devices 102 and/or service provider devices 103 via network 106. User context database 112 may also be coupled to credit card service provider server device 104, payment issuer server device 108 one or more user devices 102 and/or service provider devices 103 in other suitable manners. For example, user context database 112 may be directly connected to credit card service provider server device 104, or may be included as part of credit card service provider server device 104, in some embodiments. User context database 112 may be a single database or may include multiple different databases.

Credit card service provider server device 104 is illustrated in FIG. 1 as including a processor 120 and a computer readable memory 122 that stores computer readable instructions executable by processor 120. Computer readable memory 122 may store a card fraud protection application 124. Computer readable memory 122 may include volatile memory to store computer instructions, such as Random Access Memory (RAM), and may also include persistent memory such as a hard disk, for example. In some embodiments, credit card service provider server device 104 includes multiple processors 120. Further, in some embodiments, credit card fraud protection application 124 may be implemented using hardware components, firmware components, software components, or any combination thereof.

In the illustrated embodiment, card fraud protection application 124 includes application programming interface(s) (API) 126, user context data collection engine 128, and user context generator 130. APIs 126 facilitate integration of credit card provider server device 104 with other components of the system 100 and communication between credit card provider server device 104 and other components of the system 100, in an embodiment. For example, APIs 126 include one or more APIs that facilitate integration of credit card provider server device 104 with user devices 102 and/or the service provider devices 103, and allow credit card fraud protection application 124 to collect user context data from user devices 102 and/or service provider devices 103. APIs 126 may also include an API that facilitates integration of credit card provider server device 104 with payment issuer server device 110, and allows credit card fraud protection application 124 to provide user context to payment issuer server device 110.

User context data collection engine 128 is configured to obtain context data for a user from user devices 102 and/or service provider devices 103. In an embodiment, user context data collection engine 128 is configured to obtain context data from user devices 102 and/or service provider devices 103 periodically, such as daily at various time points throughout the day, or continuously, for example. In an embodiment, data collected from user devices 102 and/or service provider devices may include data that indicates water consumption of in a home of the user, electricity consumption in the home of the user, status of light sources (e.g., presence and/or absence of lights) in the home of the user, internet activity of the user, geographical location of the user, etc., daily at various times throughout a day, or continuously. User context data collection engine 128 may store the collected context data in user context database 112. User context data stored in user context database 112 may be organized as a plurality of entries indexed by time of day, wherein each entry may provide a user signature that indicates user environment, activities, etc., at the corresponding time of day, for example. In other embodiments, user context data stored in database 112 may be organized in other suitable manners.

User context generator 130 is configured to generate a context for a user upon receiving a request from payment issuer device 110. User context generated for the user may include a signature of the user corresponding to the time of day at which the request is received from payment issuer server device 110. User context data may indicate typical environment and activity of the user at the time of day at which the request is received from payment issuer server device 110 and/or may indicate current environment and activity of the user at the time of day at which the request is received from payment issuer server device 100, for example, in various embodiments.

In operation, a payment transaction may be initiated, and a request to process the payment may be provided (e.g., via the network 106) to payment processor device 108. Payment processor device 108 may, in turn, provide a payment request to payment issuer server device 110 (e.g., a bank) to issue payment for the transaction. In response to receiving the request from payment processor 108, payment issuer server device 110 may attempt to authenticate the payment request. Authenticating the payment request may include sending a context request or a query to credit card server device 104 to request that credit card server device 104 provide a user context for the user.

In response to receiving the context request, credit card provider server device 104 (e.g., the credit card fraud protection application 124) may generate a context for the user. For example, credit card fraud protection application 124 may query user context database 112 to obtain relevant context information collected for the user, such as context data (e.g., typical electricity consumption, current electricity consumption, status of lights (e.g., presence or absence of lights), typical location, current location, typical internet usage, etc.) corresponding to the time of day at which the payment transaction is initiated by the user. Upon obtaining the relevant information, the credit card fraud protection application 124 may generate user context that includes the relevant information. Credit card provider server device 104 may then transmit the user context back to payment issuer server device 110.

In an embodiment, prior to sending a context request to credit card server device 104, payment issuer server device 110 may determine whether the user has elected, or “opted-in,” to participate in user context fraud protection, and to send the context request only if such an election has been made by the user. In another embodiment, the determination of whether the user has elected, or “opted-in,” to participate in user context fraud protection is made by credit card provider server device 104 (e.g., by credit card fraud protection application 124), and a user context may be provided to payment issuer server device only if such an election has been made by the user. Credit card provider server 104 may determine whether the user has elected to opt-in to participate in user context fraud protection based on an opt-in indication previously obtained from the user and stored, for example, in user context database 112 or in another suitable memory coupled to or included in credit card provider server 104.

Payment issuer server device 110 may utilize the user context received from credit card provider server device 104 in authenticating the payment request and generating a decision of whether to approve or decline the payment request. In an embodiment, payment issuer server device 110 may utilize the user context to determine a likelihood that the payment request is authentic and is actually initiated by the user and not initiated by a person or entity other than the user and without user's knowledge. For example, if a geographical location of the user indicated in the user context corresponds to the geographical location at which the transaction was initiated, then the payment issuer server device 110 may decide that the transaction is likely to be authentic, and may approve the payment. As just another example, if the user context indicates that the user is likely to be at home (e.g., due to presence of lights in the home at the time when the transaction is initiated, based on typical consumption of electricity in the home at the time when the transaction is initiated, etc.), and the transaction was initiated outside of the home (e.g., at a merchant location), then the payment issuer server device 110 may decide that the transaction is likely to be fraudulent, and may decline the payment. Payment issuer server device 110 may provide an indication of the decision to payment processor device 108. Payment processor device 108 may process the indication of the decision and may approve or decline the payment in accordance with the decision.

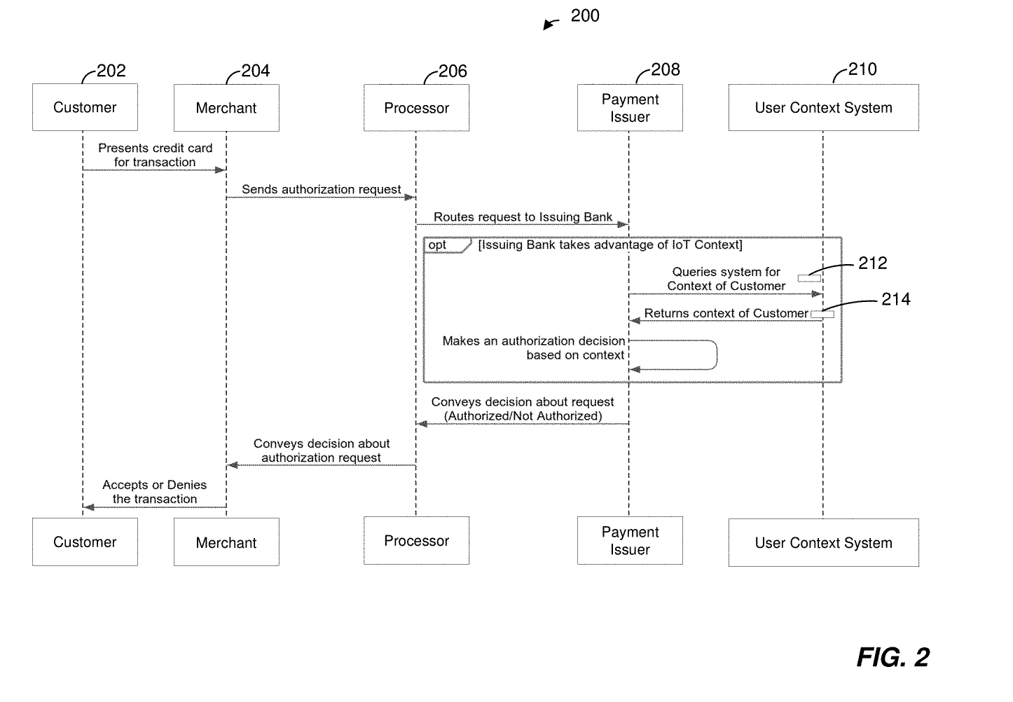

FIG. 2 is a diagram 200 illustrating an exemplary method, which may be implemented in the computing system of FIG. 1, for authenticating a payment request using user context, according to an embodiment. A customer 202 may initiate a transaction, for example by presenting a credit card (or a credit card number) to a merchant device 204. Merchant device 204 may send an authentication request to a payment processor device 206. Payment processor device 206 corresponds to the payment processor device 108 of FIG. 1, in an embodiment. Payment processor device 206 may route the authentication request to a payment issuer (e.g., bank) device 208. Payment issuer device 208 corresponds to payment issuer server device 110 of FIG. 1, in an embodiment. Payment issuer device 208 may receive the authentication request and may query a user context system 210 to obtain a context for the customer 202. Querying user context system 210 may include generating a context request 212 requesting a user context at a time a payment request is made, and transmitting context request 212. User context system 210 may be implemented in credit card provider server device 104, for example, in an embodiment. For example, user context system 210 may be implemented by credit card fraud protection application 124. User context system 210 may receive context request 212 and, in response to receiving context request 212, may generate a user context 214 indicating a signature for the customer 202. For example, user context may include information regarding typical and/or current environment of the customer 202 (e.g., electricity consumption, status of light sources, typical location, current location, typical internet usage, etc.), typical and/or current actions of the customer 202, and/or other typical and/or current characteristics of the customer 202. User context system 210 may then transmit user context 214 to payment issuer device 208. Based, at least in part, on user context 214, payment issuer device 208 may generate an authentication decision. The authentication decision may indicate whether the payment issuer is approving or declining the requested payment. Payment issuer device 208 may provide the authentication decision to payment processor device 206. Payment processor device 206 may, in turn, relay the authentication decision to merchant device 204 and, ultimately, the authentication decision may be relayed to customer 202.

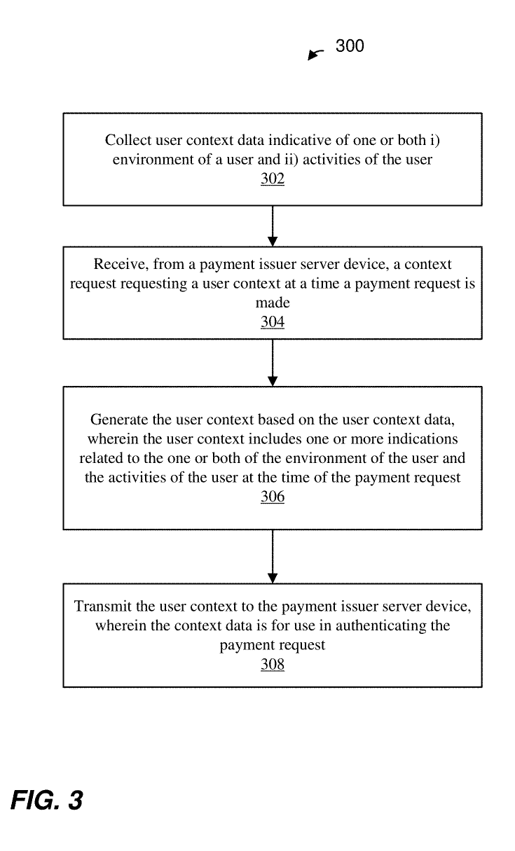

FIG. 3 is a flow diagram of a method 300 for generating user context for use in credit card transaction authentication, according to an embodiment. In such an embodiment, method 300 is implemented by a credit card provider server device such as credit card provider server device 104 of computing system 100 of FIG. 1. In an embodiment, method 300 is implemented at least partially by user context data collection engine 128 and user context generator engine 130 of credit card provider server device 104 of computing system 100 of FIG. 1. In other embodiments, method 300 is implemented by suitable computing devices different from credit card provider server device 104 of FIG. 1 and/or in suitable computing systems different from computing system 100 of FIG. 1.

At block 302, context data indicative of one or both i) environment of a user and ii) activities of the user is collected. In an embodiment, context data is collected by credit card provider server device 104 of FIG. 1, for example. Context data may be received by credit card provider server device 104 from each of one or more i) at least one IoT device 102-1 associated with the user, ii) at least one mobile device 102-2 associated with the user, iii) at least one stationary computing device 102-3 associated with the user and iv) at least one server device 103 of a provider that provides a service to the user. Context data may be received from each of the devices periodically or continually. Received context data may be indicative of one or more of i) water consumption in a home of the user, ii) electricity consumption in the home of the user, iii) status of light sources in the home of the user iii) internet activity of the user, and iv) geographical location of the user.

Context data collected at block 302 may be stored in a user context database. For example, context data may be stored in user context database 112 of FIG. 1, or may be stored in a suitable database different from user context database 112 of FIG. 1. The user context database may include a plurality of entries corresponding to the user, respective ones of the entries associated with respective different times of day. Storing the context data in the database may include associating, in the user context database, respective context data with corresponding time of day associated with the respective context data. Time of day associated with respective context data may correspond to time of day at which the respective context data is received by credit card provider server device 104, for example. As another example, respective context data received by credit card provider server device 104 may include an indication of a time of day to which the respective context data corresponds.

At block 304, a context request, requesting a user context at a time a payment request is made, is received. The context request may be received from a payment issuer server device attempting to authenticate the payment request. In an embodiment, the context request is received by credit card provider server device 104 from payment issuer server device 110 of FIG. 1, for example. In an embodiment, context request 212 of FIG. 2 is received. In another embodiment, a suitable context request different from context request 212 of FIG. 2 is received.

At block 306, user context is generated based on user context collected at block 302. In an embodiment, user context is generated by credit card provider server device 104 of FIG. 1. In an embodiment, user context request 214 of FIG. 2 is generated. In another embodiment, a suitable user context different from user context 214 of FIG. 2 is generated. The user context is generated to include one or more indications related to the one or both of the environment of the user and the activities of the user at the time of the payment request.

Generating the user context at block 306 may include identifying, in the user context database, an entry corresponding to the user, the entry corresponding to a time of day associated with the context request received at block 304. For example, the time of day associated with the context request received at block 304 may correspond to the time of day at which the context request was received by credit card provider server device 104. As another example, the time of day associated with the context request received at block 304 may correspond to a time of day indicated in context request received by credit card provider server device 104. Generating the user context may include retrieving, from the identified entry in the user context database, context data corresponding to the user, the context data providing a signature that indicates one or more of i) environment of the user and ii) activities of the user corresponding to the time of day associated with the context request received at block 304. The user context may be generated to include the context data retrieved from the identified entry in the user context database. The user context may be generated to include one or more of i) at least one indication indicative of typical environment of the user at the time of the payment request, ii) at least one indication indicative of current environment of the user at the time of the payment request, iii) at least one indication indicative of typical activities of the user at the time of the payment request and iv) at least one indication indicative of current activities of the user at the time of the payment request, for example.

At block 308, the user context generated at block 306 is transmitted. The user context may be transmitted to the payment issuer server device from which the context request was received at block 304. In an embodiment, the user context is transmitted by credit card provider server device 104 to payment issuer server device 110 of FIG. 1, for example. In an embodiment, user context 214 of FIG. 2 is transmitted to payment issuer server device from which the context request was received at block 304. In another embodiment, a suitable user context different from user request 212 of FIG. 2 is transmitted to payment issuer server device from which the context request was received at block 304. The user context may be for use in authenticating the payment request. For example, payment issuer server device may utilize the user context to determine whether to authorize the payment request or to decline the payment request as described above, in an embodiment.

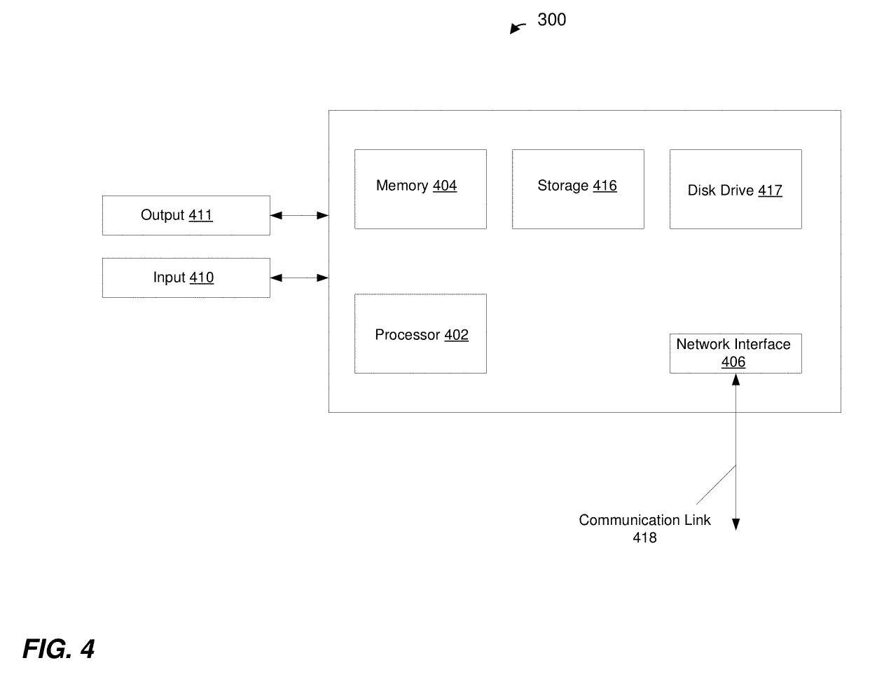

FIG. 4 is a block diagram of a computing system 400 suitable for implementing one or more embodiments of the present disclosure. In such an embodiment, each of one or more devices in the system 100 of FIG. 1 may be implemented as the computing system 400. In its most basic configuration, the computing system 400 may include at least one processor 402 and at least one memory 404. The computing device 400 may also include a bus (not shown) or other communication mechanism for communicating information data, signals, and information between various components of computer system 400. Components may include an input component 410 that processes a user action, such as selecting keys from a keypad/keyboard, selecting one or more buttons or links, etc., and sends a corresponding signal to the at least one processor 402. Components may also include an output component, such as a display, 411 that may display, for example, results of operations performed by the at least one processor 402. A transceiver or network interface 406 may transmit and receive signals between computer system 400 and other devices, such as user devices that may utilize results of processes implemented by the computer system 400. In one embodiment, the transmission is wireless, although other transmission mediums and methods may also be suitable.

The at least one processor 402, which can be a micro-controller, digital signal processor (DSP), or other processing component, processes these various signals, such as for display on computer system 400 or transmission to other devices via a communication link 418. The at least one processor 402 may also control transmission of information, such as cookies or IP addresses, to other devices. The at least one processor 402 may execute computer readable instructions stored in the memory 404. The computer readable instructions, when executed by the at least one processor 402, may cause the at least one processor 402 to implement processes associated with context data collection and user context generation for use in payment transaction authentication as described above, in some embodiments.

Components of computer system 400 may also include at least one static storage component 416 (e.g., ROM) and/or at least one disk drive 417. Computer system 400 may perform specific operations by processor 412 and other components by executing one or more sequences of instructions contained in system memory component 414. Logic may be encoded in a computer readable medium, which may refer to any medium that participates in providing instructions to the at least one processor 402 for execution. Such a medium may take many forms, including but not limited to, non-transitory media, non-volatile media, volatile media, and transmission media. In various implementations, non-volatile media includes optical or magnetic disks, volatile media includes dynamic memory, such as system memory component 416, and transmission media includes coaxial cables, copper wire, and fiber optics. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

While various operations of a credit card payment processing system have been described herein in terms of “modules” or “components,” it is noted that that terms are not limited to single units or functions. Moreover, functionality attributed to some of the modules or components described herein may be combined and attributed to fewer modules or components. Further still, while the present invention has been described with reference to specific examples, those examples are intended to be illustrative only, and are not intended to limit the invention. It will be apparent to those of ordinary skill in the art that changes, additions or deletions may be made to the disclosed embodiments without departing from the spirit and scope of the invention. For example, one or more portions of methods described above may be performed in a different order (or concurrently) and still achieve desirable results.

What is claimed is:

1. A method for generating user context for use in credit card transaction authentication, the method comprising:
collecting, using a processor of a credit card provider server device, context data indicative of one or both i) environment of a user and ii) activities of the user;
receiving, at the processor of the credit card provider server device from a payment issuer server device, a context request, the context request requesting a user context at a time a payment request is made;
in response to receiving the context request, generating, with the processor of the credit card provider server device based on the context data, the user context, wherein the user context includes one or more indications related to the one or both of the environment of the user and the activities of the user at the time of the payment request; and
transmitting the user context from the credit card provider server device to the payment issuer server device, wherein the user context is for use in authenticating the payment request.

2. The method of claim 1, wherein collecting the context data includes receiving the context data at the processor of the credit card provider server device from each of one or more of i) at least one internet of things (IoT) device associated with the user, ii) at least one mobile device associated with the user iii) at least one stationary computing device associated with the user, and iv) at least one server of a service provider that provides a service to the user.

3. The method of claim 2, wherein receiving the context data comprises receiving context data indicative of one or more of i) water consumption in a home of the user, ii) electricity consumption in the home of the user, iii) status of light sources in the home of the user iii) internet activity of the user, and iv) geographical location of the user.

4. The method of claim 1, wherein collecting the context data includes storing, with the processor, the context data in a user context database maintained by the credit card provider server device.

5. The method of claim 4, wherein
the user context database includes a plurality of entries corresponding to the user, the plurality of entries indexed by time of day, and
storing the context data in the user context database includes associating, in the user context database, respective context data with corresponding times of day associated with the respective context data.

6. The method of claim 5, wherein generating the user context comprises
identifying, with the processor in the user context database, an entry corresponding to the user, the entry indexed by a time of day associated with the context request,
retrieving, from the identified entry in the user context database, context data corresponding to the user, the context data providing a signature that indicates one or more of i) environment of the user and ii) activities of the user corresponding to the time of day associated with the context request, and
generating the user context to include the context data retrieved from the identified entry in the user context database.

7. The method of claim 1, wherein generating the user context comprises generating the user context to include one or more of i) at least one indication indicative of typical environment of the user at the time of the payment request, ii) at least one indication indicative of current environment of the user at the time of the payment request, iii) at least one indication indicative of typical activities of the user at the time of the payment request and iv) at least one indication indicative of current activities of the user at the time of the payment request.

8. The method of claim 1, wherein
the method further comprises, prior to generating the user context, determining, with the processor based on an indication stored in a memory of the credit card provider server device, whether the user has opted-in to participate in user context fraud protection, and
generating the user context comprises generating the user context in response to determining that the user has opted-in to participate in user context fraud protection.

9. A tangible, non-transitory computer readable medium, or media, storing machine-readable instructions that, when executed by one or more processors, cause the one or more processors to:
collect context data indicative of one or both i) environment of a user and ii) activities of the user;
receive, from a payment issuer server device, a context request requesting a user context at a time a payment request is made;
in response to receiving the context request, generate, based on the context data, the user context, wherein the user context includes one or more indications related to the one or both of the environment of the user and the activities of the user at the time of the payment request; and
cause the user context to be transmitted to the payment issuer server device, wherein the user context is for use in authenticating the payment request.

10. The tangible, non-transitory computer readable medium, or media of claim 9, storing machine readable instructions that, when executed by one or more processors, cause the one or more processors to receive the context data from each of one or more of i) at least one internet of things (IoT) device associated with the user, ii) at least one mobile device associated with the user iii) at least one stationary computing device associated with the user, and iv) at least one server of a service provider that provides a service to the user.

11. The tangible, non-transitory computer readable medium, or media of claim 10, storing machine readable instructions that, when executed by one or more processors, cause the one or more processors to receive context data indicative of one or more of i) water consumption in a home of the user, ii) electricity consumption in a home of the user, iii) status of light sources in the home of the user iii) internet activity of the user, and iv) geographical location of the user.

12. The tangible, non-transitory computer readable medium, or media of claim 9, storing machine readable instructions that, when executed by one or more processors, further cause the one or more processors to store the context data in a user context database maintained by the credit card provider server device.

13. The tangible, non-transitory computer readable medium, or media of claim 12, storing machine readable instructions that, when executed by one or more processors, further cause the one or more processors to store the context data in a plurality of entries corresponding to the user in the user context database, the plurality of entries indexed by time of day.

14. The tangible, non-transitory computer readable medium, or media of claim 13, storing machine readable instructions that, when executed by one or more processors, cause the one or more processors to
identify an entry corresponding to the user, the entry corresponding to a time of day associated with the context request,
retrieve, from the identified entry in the user context database, context data corresponding to the user, the context data providing a signature that indicates one or more of i) environment of the user and ii) activities of the user corresponding to the time of day associated with the context request, and
generate the user context to include the context data retrieved from the identified entry in the user context database.

15. The tangible, non-transitory computer readable medium, or media of claim 9, storing machine readable instructions that, when executed by one or more processors, cause the one or more processors to generate the user context to include one or more of i) at least one indication indicative of typical environment of the user at the time of the payment request, ii) at least one indication indicative of current environment of the user at the time of the payment request, iii) at least one indication indicative of typical activities of the user at the time of the payment request and iv) at least one indication indicative of current activities of the user at the time of the payment request.

16. The tangible, non-transitory computer readable medium, or media of claim 11, storing machine readable instructions that, when executed by one or more processors, cause the one or more processors to
prior to generating the user context, determine, based on an indication stored in a memory of the credit card provider server device, whether the user has opted-in to participate in user context fraud protection, and
generate the user context in response to determining that the user has opted-in to participate in user context fraud protection.

17. A system, comprising:
a user context database configured to store context data;
a user context collection engine coupled to the database, the user context collection engine configured to
receive context data indicative of one or both i) environment of a user and ii) activities of the user, and
store the context data in the user context database; and
a user context generator engine coupled to the database, the user context generator engine configured to
receive, from a payment issuer server device, a context request requesting a user context at a time a payment request is made;
in response to receiving the context request, generate the user context based on the context data in the user context database, wherein the user context includes one or more indications related to the one or both of the environment of the user and the activities of the user at the time of the payment request; and
cause the user context to be transmitted the payment issuer server device, wherein the user context is for use in authenticating the payment request.

18. The system of claim 17, wherein
the user context database includes a plurality of entries corresponding to the user, the plurality of entries indexed by time of day, and
the user context collection engine is configured to associate, in the context user context database, respective context data with corresponding respective times of day associated with the respective context data.

19. The system of claim 17, wherein the user context generator engine is configured to
identify, in the user context database, an entry corresponding to the user, the entry corresponding to a time of day associated with the context request,
retrieve, from the identified entry in the user context database, context data corresponding to the user, the context data providing a signature that indicates one or more of i) environment of the user and ii) activities of the user corresponding to the time of day associated with the context request, and
generate the user context to include the context data retrieved from the identified entry in the user context database.

20. The system of claim 17, wherein the user context generator engine is configured to generate the user context to include one or more of i) at least one indication indicative of typical environment of the user at the time of the payment request, ii) at least one indication indicative of current environment of the user at the time of the payment request, iii) at least one indication indicative of typical activities of the user at the time of the payment request and iv) at least one indication indicative of current activities of the user at the time of the payment request.
